(19) United States
(12) Patent Application Publication
(10) Pub. No.: US 2024/0205430 A1
(43) Pub. Date: Jun. 20, 2024

(54) Block-Based Predictive Coding For Point Cloud Compression

(71) Applicant: Apple Inc., Cupertino, CA (US)

(72) Inventors: Khaled Mammou, Danville, CA (US); David Flynn, Munchen (DE); Alexandros Tourapis, Los Gatos, CA (US); Jungsun Kim, San Jose, CA (US)

(73) Assignee: Apple Inc., Cupertino, CA (US)

(21) Appl. No.: 18/397,737

(22) Filed: Dec. 27, 2023

Related U.S. Application Data
(63) Continuation of application No. 17/062,446, filed on Oct. 2, 2020, now Pat. No. 11,895,307.
(60) Provisional application No. 62/911,200, filed on Oct. 4, 2019.

(51) Int. Cl. H04N 19/20; G06T 9/00; G06T 9/40; H04N 19/119; H04N 19/12; H04N 19/124; H04N 19/136; H04N 19/176; H04N 19/189; H04N 19/50; H04N 19/61; H04N 19/64

(52) U.S. Cl. CPC H04N 19/20; G06T 9/001; G06T 9/40; H04N 19/119; H04N 19/12; H04N 19/124; H04N 19/136; H04N 19/176; H04N 19/189; H04N 19/50; H04N 19/61; H04N 19/647

(57) ABSTRACT

An encoder is configured to compress point cloud information using a blocks of nodes determined from a prediction tree. A prediction tree is generated for a point cloud. Segments of the prediction tree are identified. The segments are divided into blocks that are predicted by predecessor blocks within the segments. The blocks of the prediction tree may then be encoded and may be provided for transmission to a decoder that can regenerate the point cloud from the blocks of the prediction tree.

### PRIORITY CLAIM

This application is a continuation of U.S. patent application Ser. No. 17/062,446, filed Oct. 2, 2020, which claims benefit of priority to U.S. Provisional Application Ser. No. 62/911,200, entitled “BLOCK-BASED PREDICTIVE CODING FOR POINT CLOUD COMPRESSION,” filed Oct. 4, 2019, and which are incorporated herein by reference in their entirety.

### TECHNICAL FIELD

This disclosure relates generally to compression and decompression of point clouds comprising a plurality of points, each having associated spatial and/or attribute information.

### DESCRIPTION OF THE RELATED ART

Various types of sensors, such as light detection and ranging (LIDAR) systems, 3-D-cameras, 3-D scanners, etc. may capture data indicating positions of points in three dimensional space, for example positions in the X, Y, and Z planes. Also, such systems may further capture attribute information in addition to spatial information for the respective points, such as color information (e.g. RGB values), intensity attributes, reflectivity attributes, motion related attributes, modality attributes, or various other attributes. In some circumstances, additional attributes may be assigned to the respective points, such as a time-stamp when the point was captured. Points captured by such sensors may make up a “point cloud” comprising a set of points each having associated spatial information and one or more associated attributes. In some circumstances, a point cloud may include thousands of points, hundreds of thousands of points, millions of points, or even more points. Also, in some circumstances, point clouds may be generated, for example in software, as opposed to being captured by one or more sensors. In either case, such point clouds may include large amounts of data and may be costly and time-consuming to store and transmit.

### SUMMARY OF EMBODIMENTS

In various embodiments, block-based predictive coding techniques are implemented to compress or otherwise encode information for point clouds, such as spatial or other geometric information or other attribute values. A prediction tree is generated for a point cloud. Segments of the prediction tree are identified. The segments are divided into blocks that are predicted by predecessor blocks within the segments. The blocks of the prediction tree may then be encoded and may be provided for transmission to a decoder that can regenerate the point cloud from the blocks of the prediction tree.

### BRIEF DESCRIPTION OF THE DRAWINGS

FIG. 1 illustrates a system comprising a sensor that captures information for points of a point cloud and an encoder that compresses attribute information and/or spatial information of the point cloud, where the compressed point cloud information is sent to a decoder, according to some embodiments.

FIG. 2A is a high-level flowchart illustrating various techniques for block-based predictive coding for point clouds, according to some embodiments.

FIG. 2B is an example prediction tree, according to some embodiments.

FIG. 2C is an example of identified segments of a prediction tree, according to some embodiments.

FIG. 2D is an example of a segment of a prediction tree divided into blocks, according to some embodiments.

FIG. 3 is a high-level flowchart illustrating various techniques for generating a prediction tree according to a space filling curve, according to some embodiments.

FIG. 4 is a high-level flowchart illustrating various techniques for generating a prediction tree according to a buffer of possible predictors, according to some embodiments.

FIG. 5 is high-level flowchart illustrating various techniques for encoding prediction tree blocks, according to some embodiments.

FIG. 6 is a high-level flowchart illustrating various techniques for decoding prediction tree blocks for a point cloud, according to some embodiments.

FIG. 7 is high-level flowchart illustrating various techniques for decoding prediction tree blocks, according to some embodiments.

FIG. 8A illustrates components of an encoder, according to some embodiments.

FIG. 8B illustrates components of a decoder, according to some embodiments.

FIG. 9 illustrates compressed point cloud information being used in a 3-D application, according to some embodiments.

FIG. 10 illustrates compressed point cloud information being used in a virtual reality application, according to some embodiments.

FIG. 11 illustrates an example computer system that may implement an encoder or decoder, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f), for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### DETAILED DESCRIPTION

As data acquisition and display technologies have become more advanced, the ability to capture point clouds comprising thousands or millions of points in 2-D or 3-D space, such as via LIDAR systems, has increased. Also, the development of advanced display technologies, such as virtual reality or augmented reality systems, has increased potential uses for point clouds. However, point cloud files are often very large and may be costly and time-consuming to store and transmit. For example, communication of point clouds over private or public networks, such as the Internet, may require considerable amounts of time and/or network resources, such that some uses of point cloud data, such as real-time uses, may be limited. Also, storage requirements of point cloud files may consume a significant amount of storage capacity of devices storing the point cloud files, which may also limit potential applications for using point cloud data.

In some embodiments, an encoder may be used to generate a compressed point cloud to reduce costs and time associated with storing and transmitting large point cloud files. In some embodiments, a system may include an encoder that compresses attribute information and/or spatial information (also referred to herein as geometry information) of a point cloud file such that the point cloud file may be stored and transmitted more quickly than non-compressed point clouds and in a manner such that the point cloud file may occupy less storage space than non-compressed point clouds. In some embodiments, compression of spatial information and/or attributes of points in a point cloud may enable a point cloud to be communicated over a network in real-time or in near real-time. For example, a system may include a sensor that captures spatial information and/or attribute information about points in an environment where the sensor is located, wherein the captured points and corresponding attributes make up a point cloud. The system may also include an encoder that compresses the captured point cloud attribute information. The compressed attribute information of the point cloud may be sent over a network in real-time or near real-time to a decoder that decompresses the compressed attribute information of the point cloud. The decompressed point cloud may be further processed, for example to make a control decision based on the surrounding environment at the location of the sensor. The control decision may then be communicated back to a device at or near the location of the sensor, wherein the device receiving the control decision implements the control decision in real-time or near real-time. In some embodiments, the decoder may be associated with an augmented reality system and the decompressed spatial and/or attribute information may be displayed or otherwise used by the augmented reality system. In some embodiments, compressed attribute information for a point cloud may be sent with compressed spatial information for points of the point cloud. In other embodiments, spatial information and attribute information may be separately encoded and/or separately transmitted to a decoder.

In some embodiments, a system may include a decoder that receives one or more point cloud files comprising compressed attribute information via a network from a remote server or other storage device that stores the one or more point cloud files. For example, a 3-D display, a holographic display, or a head-mounted display may be manipulated in real-time or near real-time to show different portions of a virtual world represented by point clouds. In order to update the 3-D display, the holographic display, or the head-mounted display, a system associated with the decoder may request point cloud files from the remote server based on user manipulations of the displays, and the point cloud files may be transmitted from the remote server to the decoder and decoded by the decoder in real-time or near real-time. The displays may then be updated with updated point cloud data responsive to the user manipulations, such as updated point attributes.

In some embodiments, a system, may include one or more LIDAR systems, 3-D cameras, 3-D scanners, etc., and such sensor devices may capture spatial information, such as X, Y, and Z coordinates for points in a view of the sensor devices. In some embodiments, the spatial information may be relative to a local coordinate system or may be relative to a global coordinate system (for example, a Cartesian coordinate system may have a fixed reference point, such as a fixed point on the earth, or may have a non-fixed local reference point, such as a sensor location).

In some embodiments, such sensors may also capture attribute information for one or more points, such as color attributes, reflectivity attributes, velocity attributes, acceleration attributes, time attributes, modalities, and/or various other attributes. In some embodiments, other sensors, in addition to LIDAR systems, 3-D cameras, 3-D scanners, etc., may capture attribute information to be included in a point cloud. For example, in some embodiments, a gyroscope or accelerometer, may capture motion information to be included in a point cloud as an attribute associated with one or more points of the point cloud. For example, a vehicle equipped with a LIDAR system, a 3-D camera, or a 3-D scanner may include the vehicle's direction and speed in a point cloud captured by the LIDAR system, the 3-D camera, or the 3-D scanner. For example, when points in a view of the vehicle are captured they may be included in a point cloud, wherein the point cloud includes the captured points and associated motion information corresponding to a state of the vehicle when the points were captured.

In some embodiments, attribute information may comprise string values, such as different modalities. For example attribute information may include string values indicating a modality such as “walking”, “running”, “driving”, etc. In some embodiments, an encoder may comprise a “string-value” to integer index, wherein certain strings are associated with certain corresponding integer values. In some embodiments, a point cloud may indicate a string value for a point by including an integer associated with the string value as an attribute of the point. The encoder and decoder may both store a common string value to integer index, such that the decoder can determine string values for points based on looking up the integer value of the string attribute of the point in a string value to integer index of the decoder that matches or is similar to the string value to integer index of the encoder.

In some embodiments, an encoder compresses and encodes geometric or other spatial information of a point cloud in addition to compressing attribute information for attributes of the points of the point cloud.

In some embodiments, some applications may be sensitive to the latency or time that is taken to encode and decode point cloud. While some point cloud encoding techniques may implement features that provide good compression results, such as octrees utilized in Geometry-based Point Cloud Compression (G-PCC), the time to encode and decode point cloud data may limit the utilization of the compression in latency sensitive applications. For example, while octree techniques may provide excellent compression results for dense point cloud, the compression gains achieved for a sparse point cloud (e.g. a sparse Lidar point cloud) may not be as effective, as the computational complexity for building the octree and computing features of the octree, such as neighborhood occupancy information, may result in computational costs that outweigh the obtained compression gains. Furthermore, in some scenarios, some coding techniques, like octree-based coding, may incur a high latency (e.g., by using a high number of points before the compression/decompression process could start). Predictive coding techniques, in various embodiments, may provide various performance benefits, including low latency implementations, which can achieve more performant computational costs and lower latency. For example, predictive coding techniques as discussed below may be implemented for low latency or other latency sensitive applications, allow for low delay streaming, and be implemented with low complexity decoding.

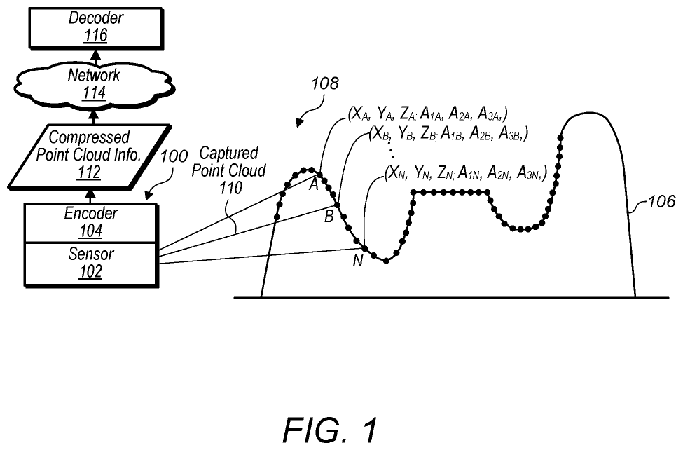

FIG. 1 illustrates a system comprising a sensor that captures information for points of a point cloud and an encoder that compresses spatial and/or attribute information of the point cloud, where the compressed spatial and/or attribute information is sent to a decoder, according to some embodiments.

System 100 includes sensor 102 and encoder 104. Sensor 102 captures a point cloud 110 comprising points representing structure 106 in view 108 of sensor 102. For example, in some embodiments, structure 106 may be a mountain range, a building, a sign, an environment surrounding a street, or any other type of structure. In some embodiments, a captured point cloud, such as captured point cloud 110, may include spatial and attribute information for the points included in the point cloud. For example, point A of captured point cloud 110 comprises X, Y, Z coordinates and attributes 1, 2, and 3. In some embodiments, attributes of a point may include attributes such as R, G, B color values, a velocity at the point, an acceleration at the point, a reflectance of the structure at the point, a time stamp indicating when the point was captured, a string-value indicating a modality when the point was captured, for example “walking”, or other attributes. The captured point cloud 110 may be provided to encoder 104, wherein encoder 104 generates a compressed version of the point cloud (compressed point cloud information 112) that is transmitted via network 114 to decoder 116. In some embodiments, a compressed version of the point cloud, such as compressed point cloud information 112, may be included in a common compressed point cloud that also includes compressed spatial information for the points of the point cloud or, in some embodiments, compressed spatial information and compressed attribute information may be communicated as separate files.

In some embodiments, encoder 104 may be integrated with sensor 102. For example, encoder 104 may be implemented in hardware or software included in a sensor device, such as sensor 102. In other embodiments, encoder 104 may be implemented on a separate computing device that is proximate to sensor 102.

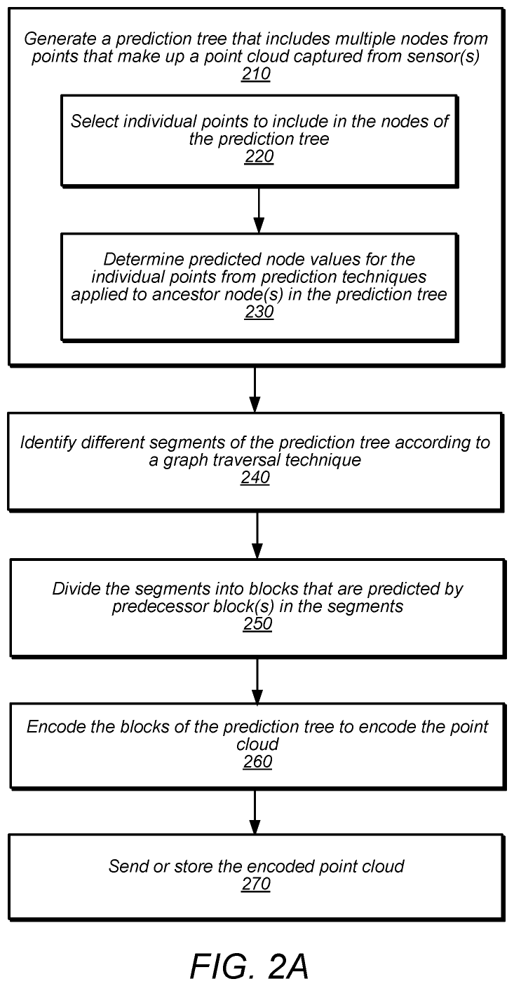

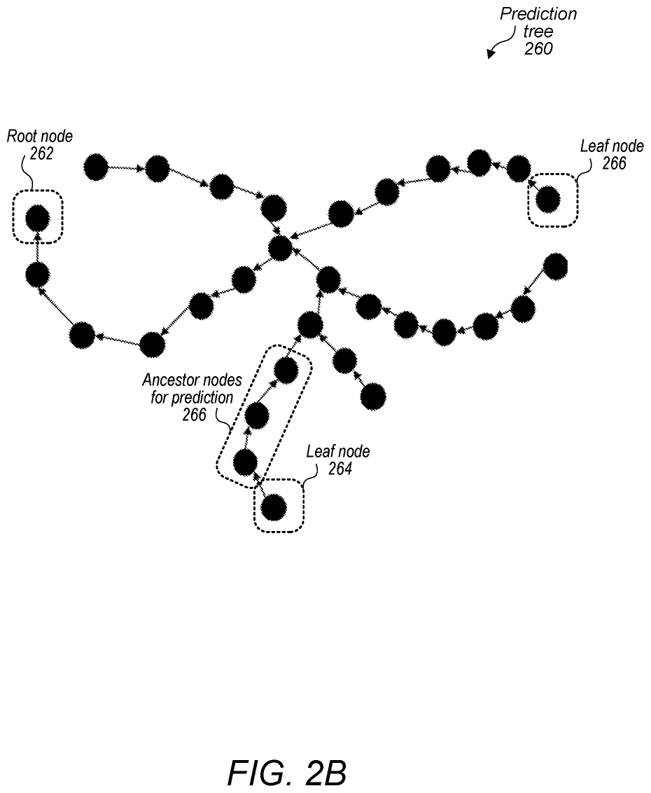

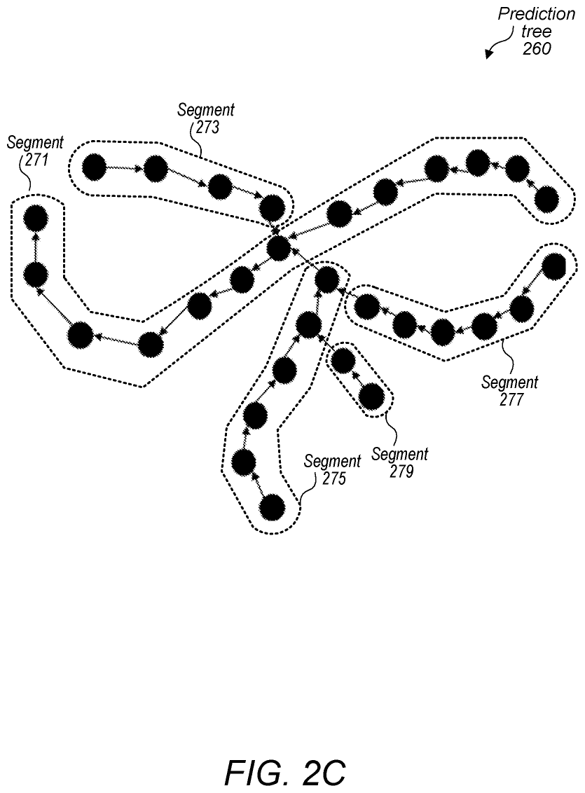

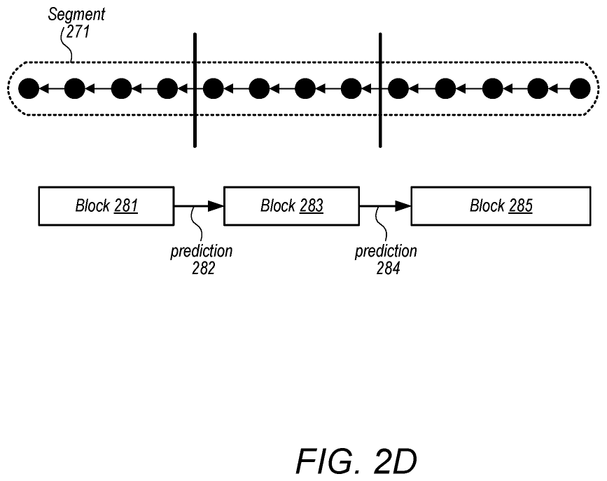

FIG. 2A is a high-level flowchart illustrating various techniques for block-based predictive coding for point clouds, according to some embodiments. As indicated at 210, a prediction tree may be generated that includes multiple nodes from points that make up a point cloud captured from sensor(s), in various embodiments. A prediction tree may serve as a prediction structure, where each point in the point cloud is associated with a node (sometimes referred to as a vertex) of the prediction tree, in some embodiments. In some embodiments, each node may be predicted from only the ancestors of the node in the tree.

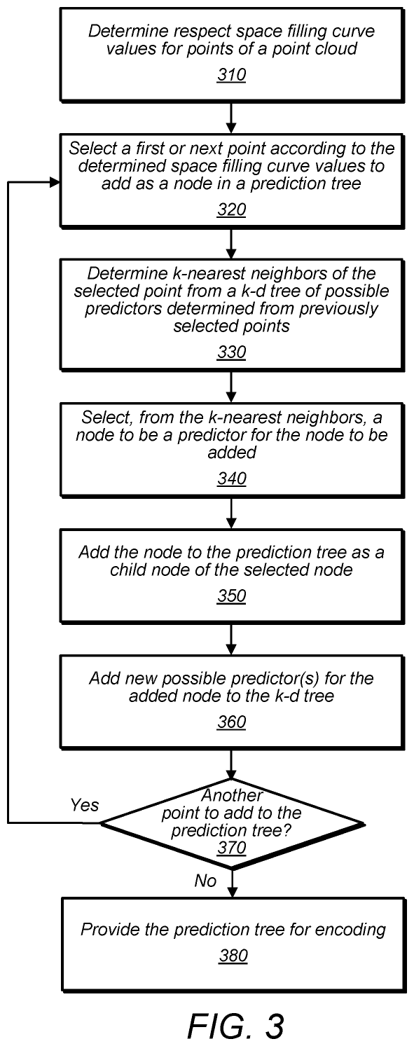

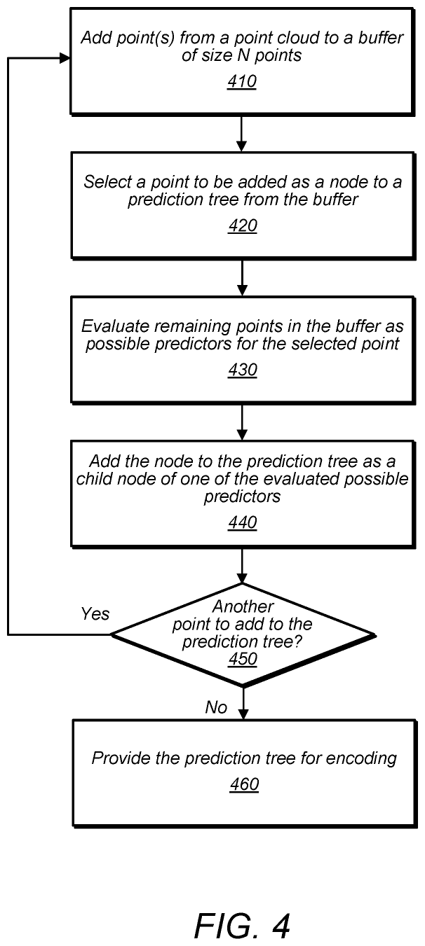

As part of generating the prediction tree, individual points of the point cloud may be selected for inclusion in the prediction tree, as indicated at 220. As indicated at 230, predicted node values may be determined for the individual points from prediction techniques applied to ancestor nodes in the prediction tree, in some embodiments. FIGS. 3 and 4, discussed below, provide examples prediction tree generation techniques.

Various prediction techniques may be implemented to predict a node from ancestor nodes. These prediction techniques may be signaled as prediction modes or prediction indicators (e.g., mapped to prediction mode values “0”=prediction technique A, “1”=prediction technique B, and so on). In some embodiments, a node in the prediction tree (corresponding to one point in the point cloud) may not have a prediction technique as it may be the first or root node of the prediction tree. The prediction mode for such a node may be indicated as “none” or “root” in some embodiments. The actual information (e.g., spatial information and/or attribute information) for such a node may be encoded instead of the residual information encoded for other nodes in the tree that is used to derive the actual information when applied to predicted values.

As illustrated in FIG. 2B, prediction tree 260 may include various nodes that are predicted according to a prediction technique applied to one or more ancestor nodes, indicated by the arrows. For example, leaf node 264 may be predicted by ancestor nodes 266, according to various ones of the prediction techniques discussed below. Some nodes, like root node 262, may not be predicted but encoded as part of prediction tree 260 using the actual values. Other nodes, like leaf node 266, may be predicted according to a single ancestor node.

In some embodiments, delta prediction may be implemented or supported as a prediction technique. Delta prediction may use a position of a parent node of a current node as a predictor of the current node.

In some embodiments, linear prediction may be implemented or supported as a prediction technique. For example, in linear prediction, a point “p0” may be the position of a parent node and “p1” may be the position of a grandparent node. The position of a current node may be predicted as (2× p0−p1).

In some embodiments, parallelogram prediction may be implemented or supported as a prediction technique. For example, in parallelogram prediction “p0” may be the position of the parent node, “p1” the position of the grandparent node, and “p2” be the position of the great-grandparent node. A current node's position may then be determined as (p0+p1−p2).

In some embodiments, rectangular prediction may be implemented or supported as a prediction technique. For example, in rectangular prediction “p0” may be the position of the parent node, “p1” the position of the grandparent node, and “p2” be the position of the great-grandparent node. A current node's position may then be determined as (p0+p2−p1).

In some embodiments, polar prediction may be implemented or supported as a prediction technique. For example, in polar prediction (θ₀, r₀, z₀) may be the polar coordinates of the parent node and (θ₁, r₁, z₁) may be the polar coordinates of the grandparent node. The position of the current node is predicted as

$$( 2 {θ}_{0} - {θ}_{1} , {\frac{{r}_{0 +} {r}_{1}}{2}}_{0} , \frac{{z}_{0 +} {z}_{1}}{2} ) .$$

In some embodiments, modified polar prediction may be implemented or supported as a prediction technique. For example, in modified polar prediction (θ₀, r₀, z₀) may be the polar coordinates of the parent node and (θ₁, r₁, z₁) be the polar coordinates of the grandparent node. The position of the current node may be predicted as (2θ₀−θ₁, r₀, z₀).

In some embodiments, average prediction may be implemented or supported as a prediction technique. For example, in average prediction “p0” may be the position of the parent node and “p1” the position of the grandparent node. The position of the current node may be predicted as ((p0+p1)/2).

In some embodiments, average prediction of order 3 may be implemented or supported as a prediction technique. For example, in average prediction of order 3, “p0” may be the position of the parent node, “p1” may be the position of the grandparent node and “p2” may be the position of the great-grandparent node. The position of the current node may be predicted as ((p0+p1+p2)/3).

In some embodiments, average prediction of order k may be implemented or supported as a prediction technique. For example, in average prediction of order k, the positions of ancestor nodes of the current node may be averaged up to the order k ancestor nodes.

The choice of the prediction technique to be applied for each node of the prediction tree may be determined according to a rate-distortion optimization procedure, in some embodiments. In some embodiments, the choice may be adaptive per node or per group of nodes. In some embodiments, the choice may be signaled explicitly in the bitstream or may be implicitly derived based on the location of the node if the prediction graph and decoded positions and prediction modes of the node ancestors. In some embodiments, the choice may be signaled at a block-level for a set of nodes included in a block of a segment of the prediction tree.

The prediction tree may be encoded, including the prediction techniques applied to determine the predicted node values. For example, a node may be encoded along with a number of child nodes, and respective prediction modes to determine each child node (which may be the same for each child, different for each child, or independently determined for each child (even if determined to be the same) in some embodiments). In various embodiments, the prediction tree may be encoded by traversing the tree in a predefined order (e.g., depth first, breath first) and encoding for each node the number of its children. The positions of the nodes may be encoded by encoding first the chosen prediction mode and then the obtained residuals after prediction, in some embodiments. In various embodiments, the number of children and the prediction mode for nodes can be encoded.

In various embodiments, the prediction residuals could be encoded (e.g., arithmetically encoded) in order to further exploit statistical correlations. The residuals could be encoded by compressing the sign of each residue, the position of the most significant bit (equivalent to Floor(Log 2(Abs(residue)))) and the binary representation of the remaining bits, in some embodiments. Correlations between the X, Y, Z coordinates could be exploited by using a different entropy/arithmetic context based on the encoded values of the first encoded components, in some embodiments.

Block-based predictive coding techniques may be implemented for encoding residuals, in various embodiments. For example, as indicated at 240, different segments of the prediction tree may be identified according to a graph traversal technique, in some embodiments. For example, a traversal technique may start with a root node (e.g., root node 262 in FIG. 2) and traverse the nodes until a leaf node is reached. This first path may be a first segment. For example, as illustrated in FIG. 2C, segment 271 may include root node 262 and may traverse a path until a leaf node, like leaf node 266, is reached. A next node in a traversal order according to a traversal technique may be selected to identify another segment that ends with another leaf node. For instance, segment 273 may be identified. Some techniques may be iteratively performed until each node of a prediction tree is identified in a segment. In FIG. 2C, for example, segments 275, 277, and 279, may also be identified which together with segments 271 and 273 may divide prediction tree into different segments that together include all of the nodes of prediction tree 260. Although the example traversal technique discussed above may be used to identify segments, in some embodiments, many traversal techniques could be applied in various embodiments (e.g., depth first search, breadth first search, and so on).

As indicated at 250, the segments of the prediction tree may be divided into blocks that are predicted by prior block(s) in the segments, in various embodiments. For example, a segment may be divided into blocks of various sizes (e.g., 4 nodes, 16 nodes, 32 nodes, 64 nodes, 128 nodes, and so on). In some embodiments, block size could be determined based on Rate Distortion Optimization (RDO) in order to minimize the reconstruction errors under a predefined budget of bits. FIG. 2D illustrates an example of dividing a segment into blocks. Segment 271 may be divided into blocks 281, 283, and 285 including or representing the corresponding nodes of the divided segment.

In various embodiments, one (or more) blocks may predict another block by considering the geometry or other shape information and/or attribute values of predecessor block(s) in the segment. For instance, as illustrated in FIG. 2C, block 281 may be used to determine a prediction 282 for block 283, which may in turn be used to generate a prediction 284 for block 285 (which may also be predicted based on block 281, in some scenarios).

Similar to the prediction techniques between nodes in the prediction graph discussed above, different prediction techniques between blocks may be used, which may be referred to or signaled as block prediction modes, in some embodiments. For example, multiple prediction techniques may be potentially applied for blocks and an RDO technique may be implemented to select one to apply between them. In some embodiments, the block-prediction mode for a block may be explicitly identified in an encoding of a block (e.g., by signaling a block prediction mode value. In other embodiments, a block prediction mode may be implicit in a prediction tree and may be derived or otherwise determined according to modes of previous blocks and the position of the block in the prediction tree.

In some embodiments, a block prediction mode may include an averaging technique. For example, the spatial information and/or attribute values of a block may be predicted by the average spatial information (e.g., geometry) and/or attribute values of the points of a predecessor block, which may be the immediately adjacent block identified according to an edge that connects a node in each of the blocks, such as block 281 and block 283 illustrated in FIG. 2C.

In some embodiments, a block prediction mode may be based on an individual node. For example, a prediction may be performed using the spatial information and/or attribute values of a parent node of the first node in the block, in one embodiment. For example, if node D is in block 281 and is a parent of node F in block 283 (which may be the first node in block 283), then the spatial information and/or attribute values of node D may be used to predict block 283.

In some embodiments, a block prediction mode may be based on various extrapolation techniques. For example, extrapolation techniques (e.g., linear, polynomial, conic, or others) may be applied to the values of a predecessor block, which may be immediately adjacent, in order to predict the node values in the current block.

In some embodiments, a block prediction mode may be based on a curve fitting technique. For example, an immediately adjacent predecessor block may be used to perform curve fitting techniques. In some embodiments, a decedent block, which may be an immediately adjacent decedent bloc, may be used to perform curve fitting techniques.

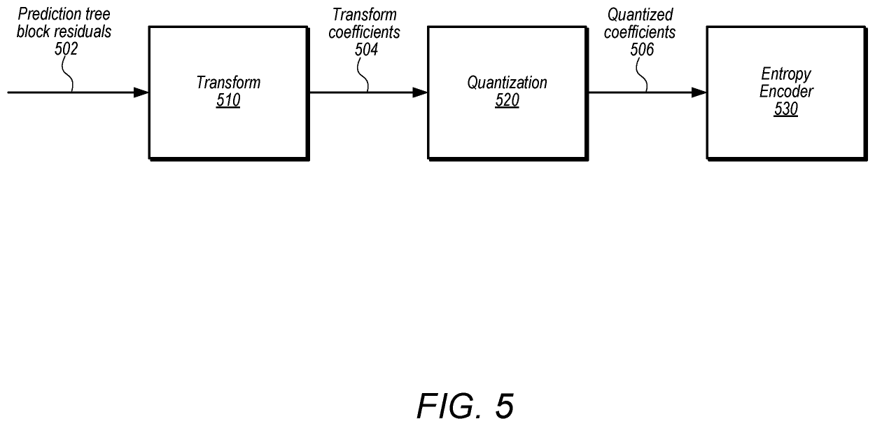

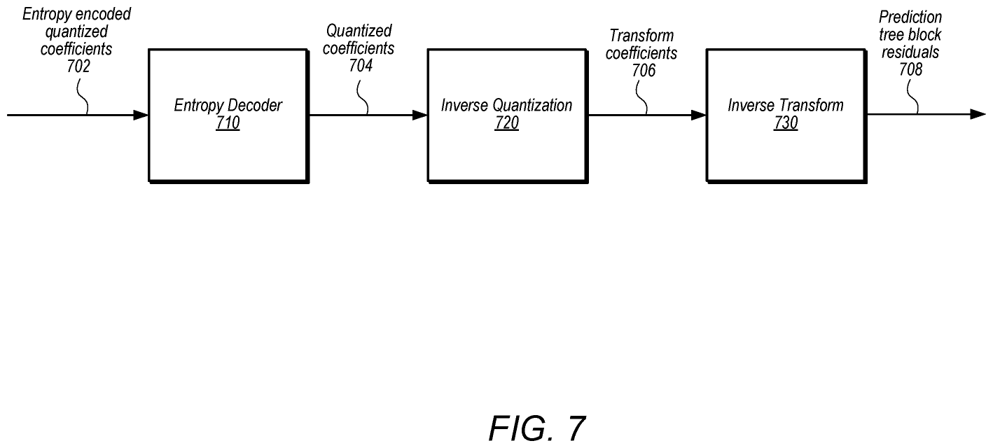

As indicated at 260, the blocks of the prediction tree may be then be encoded to encode the point cloud, according to some embodiments. FIG. 5, discussed below, discusses various example techniques for transforming encoding transformed residuals for blocks of points of a point cloud. As indicated at 270, the encoded prediction tree for the point cloud may be sent or stored, according to the various examples discussed above with regard to FIG. 1 and below with regard to FIGS. 7A, 8 and 9.

FIG. 3 is a high-level flowchart illustrating various techniques for generating a prediction tree according to a space filling curve, according to some embodiments. As indicated at 310, a space filling curve (e.g., a Morton order) may be used to determine values (e.g., Morton codes) for points of a point cloud, in some embodiments. As indicated at 320, a first or next point according to the space filling curve values may be selected to add as a node in a prediction tree, in some embodiments.

As indicated at 330, k-nearest neighbors of the selected point may be determined from a k-dimensional (k-d) tree of possible predictors determined from previously selected points, in some embodiments. As indicated at 340, from the k-nearest neighbors, a node may be selected to a predictor for the node to be added, in some embodiments. For example, the node may be selected according to the magnitude of prediction residuals, the number of children the node has, and/or the frequency of the chosen prediction mode, in some embodiments. As indicated at 350, the child node may be added to the prediction tree as a child node of the selected node, in some embodiments. New possible predictor(s) (e.g., predicted values generated from the prediction techniques discussed above) for the added node may be added to the k-d tree, as indicated at 360, in some embodiments. As indicated at 380, if another point remains to be added to the prediction tree, then the features of the technique may be repeated. When all points are added, the prediction tree may be provided for encoding, as indicated at 380.

In some embodiments, the points may be decomposed into various levels of detail (LODs) before performing the techniques illustrated in FIG. 3. For example, the LODs may be encoded starting from the coarsest LOD to the finest LOD. In such an embodiment, the potential predictors and predicted positions in the k-d tree. In some embodiments, different quantization parameters may be used for a different LOD (e.g., a smaller quantization step for the coarsest LOD) in order to obtain better rate distortion (RD) performance. In some embodiments, functionalities of temporal scalability, spatial scalability, quality scalability, and progressive transmission may be implemented utilizing LODs or other hierarchical prediction structure. In this way, the coarse LOD may be streamed and decoded first, and then progressively more granular LODs may be streamed and decoded adaptively based on network conditions, terminal capabilities, and a distance of the point cloud to a viewer, in some embodiments.

For a lower latency approach (when compared with the techniques of FIG. 3), an encoder may process the input point cloud in the same order it is received, in some embodiments. A limited buffering buffer N may be implemented that is measured in terms of number of buffered points B is allowed (e.g., B=1024 points), in some embodiments. B may be a decoder parameter that could be adjusted depending on the how stringent the application latency requirements are. When looking for the best predictor for each vertex, the encoder would consider only the points that are in the buffer, in some embodiments.

FIG. 4 is a high-level flowchart illustrating various techniques for generating a prediction tree according to a buffer of possible predictors, according to some embodiments. As indicated at 410, point(s) from a point cloud may be added to a buffer of size N points, in some embodiments. As indicated at 420, a point to be added as a node to a prediction tree may be selected, from the buffer, in some embodiments. As indicated at 430, remaining points in the buffer may be evaluated as possible predictors for the selected point. For instance, as discussed above with regard to FIG. 3, the remaining points in the buffer may be evaluated according to the magnitude of prediction residuals, the number of children the corresponding node of the points has, and/or the frequency of the chosen prediction mode, in some embodiments.

As indicated at 440, the node may be added to the prediction tree as a child node of one of the evaluated possible predictors, in some embodiments. If another point remains to be added to the prediction tree, then as indicated by the positive exit from 450, elements 410 through 440 may be added to the prediction tree. When all points have been added to the prediction tree, then the prediction tree may be provided for encoding, in some embodiments.

In some embodiments, the prediction tree could be used to compress or otherwise encode spatial information, such as geometry, or various other attributes (e.g., color information). In some scenarios, the same predictors of different nodes could be used and potentially explicitly encoded in the bitstream for the attributes. The scalability and low-latency properties can be directly be inherited from the prediction tree generation strategy.

In an alternative embodiment, the predictive coding technique may be applied only for the spatial information, while alternative techniques may be used for encoding attributes (e.g., lifting, Region Adaptive Hierarchical Transform (RAHT) or prediction scheme for the attributes according to the G-PCC attributes encoding scheme). In order to enable low latency application, the Morton re-ordering of the points that would be otherwise applied before the attributes coding would be disabled, in some embodiments.

In some embodiments, hierarchical prediction and lifting schemes (e.g., as defined in G-PCC (Geometry-based point cloud compression standards adopted by MPEG or other entities) could be modified to exploit the prediction scheme to guide the decimation and nearest neighbor's detection processes. For example, the decimation process could be applied by using edge collapse operators or any other topological decimation operator.

The criteria to choose the edge-collapse operation or other topological decimation operations to be applied to generate LODs could be guided by distance criteria (e.g., distance between the merged points) and/or explicit information included by the encoder in the bitstream, in some embodiments. The nearest neighbor search could be restricted to the neighbors in the tree structure or could use the prediction tree structure to accelerate it, in some embodiments.

FIG. 5 is a logical block diagram of encoding blocks of a prediction tree, according to some embodiments. As indicated at 502, block residuals of a prediction tree may be transformed, as indicated at 510. The residuals 502 may be the residuals for the spatial information and/or attributes of the points of the blocks. Transform 510 may apply various transformation techniques to residuals 502, in some embodiments. In some embodiments, transformation techniques applied to spatial information residuals may utilize the prediction tree structure. In some embodiments, transformation techniques for attributes of the points of the blocks may utilize both the prediction tree structure and reconstructed spatial information (e.g. the geometry information of the point cloud). In some embodiments, the geometry information provided to an encoder may be utilized without necessarily requiring a reconstruction.

Similar to block-based prediction techniques, multiple transformation techniques may be implemented, in some embodiments, which may be referred to as block residual transformation modes. In some embodiments, an RDO technique may be implemented to select one to apply. In some embodiments, the block residual transformation mode for a residuals of a block may be explicitly identified in an encoding of a block (e.g., by signaling a block residual transformation mode value). In other embodiments, a block residual transformation mode may be implicit in a prediction tree and may be derived or otherwise determined according to modes of previous blocks and the position of the block in the prediction tree. Some examples of transformation techniques that may be implemented in some embodiments include, but are not limited to, One Dimensional (1D) Discrete Cosine Transform (DCT), wavelet transform, Discrete Wavelet Transform (DWT), Haar transforms, Hadamard transform, graph transforms, lifting schemes defined on top of a local graph structure, and transforms used in codecs such as High Efficiency Video Coding (HEVC) and/or Versatile Video Coding (VVC) that are applied to 1D signals, in some embodiments.

As indicated at 504, the coefficients 504 generated as a result of transform 510 applied to prediction tree block residuals 502 may be provided to a quantization stage, as indicated 520, in various embodiments. For example, quantization 520 may provide a uniform quantization technique to coefficients, in some embodiments, and in other embodiments, may apply a non-uniform quantization technique. In at least some embodiments, a quantization coefficient may be pre-scaled to compensate for unitary transforms applied at 510. In some embodiments, an integer version of the transformed coefficients may be considered or evaluated, which may achieve a more robust result and allow for perfect reconstruction and lossless/near-loss encoding.

In some embodiments, quantization parameters used at quantization 520 may be varied per prediction tree block. For example, quantization parameters could be varied for rate control purposes or to adaptively adjust the reconstruction quality based on other criteria (e.g., Region of Interest (ROI), view-dependent coding, and so on). In some embodiments, the quantization parameters and/or transform selected for a block may be signaled to a decoder at a block-level. For example, a decoder may apply an inverse quantization and/or inverse transform. The decoder may select/modify the inverse quantization based on quantization parameters signaled for a block in the bit stream. Likewise, the decoder may select/modify an inverse quantization function to be applied to the coefficients for a block based on information in the bit stream indicating a transform applied to the residuals for the block at the encoder. In some embodiments, an encoder and a decoder may follow a similar transformation and/or quantization scheme such that transforms and quantization parameters may be implied.

Quantization techniques applied at quantization 520 may depend upon a transformation technique applied to a block, in some embodiments. For example, different quantization techniques could vary the reconstruction quality achieved in different scenarios. For instance, a quantization technique could be used for lossless coding, providing a perfect reconstruction of the spatial information and/or attribute values. A quantization technique could be used for near-lossless coding, providing a maximum reconstruction error that is guaranteed for spatial information and/or attribute values. A quantization technique could be used for lossy coding, providing a maximum reconstruction error that is guaranteed for the average spatial information and/or attribute values.

As indicated at 506, the quantized coefficients may be entropy encoded at entropy encoder 530, in some embodiments, as part of encoding the point cloud.

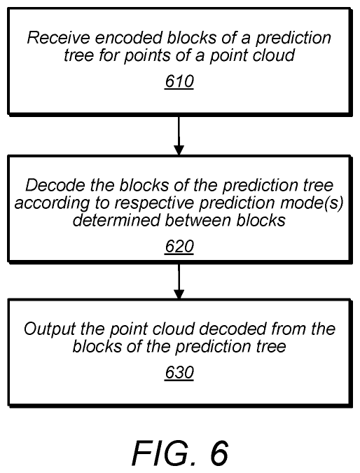

FIG. 6 is a high-level flowchart illustrating various techniques for decoding prediction tree blocks for a point cloud, according to some embodiments. As indicated at 610 encoded blocks of a prediction tree for points of a point cloud may be received, in some embodiments. As indicated at 620, the encoded blocks of the prediction tree for the points of the point cloud may be decoded. For example, techniques to undo entropy or other encoding techniques may be performed.

In at least some embodiments, the encoded prediction tree may include enough information to generate the points of the point cloud from the blocks of the prediction tree (e.g., without performing the same tree generation techniques discussed above with regard to FIGS. 3 and 4). For example, a selected block (e.g. a block containing a root node) may be decoded as a first block containing a first point in the point cloud. Then, the nodes within the selected block may be decoded according to prediction modes included between the nodes in the block, in some embodiments. Then, a prediction mode for a next block may be used to decode a next block of the prediction tree, so that the nodes within the next block may be decoded. This technique may repeat until the nodes of each of the blocks are decoded to determine the point cloud. Once complete the decoded point cloud from the prediction tree may be output, as indicated at 660 (e.g., for further processing, display, and/or storage).

In some embodiments, wherein a transform has been applied to the residual values of the block and or a quantization operation, an inverse transformation and/or an inverse quantization may be applied as part of decoding a block. For example, FIG. 7 illustrates high-level flowchart illustrating various techniques for decoding prediction tree blocks, according to some embodiments.

In some embodiments, a decoder may receive entropy encoded quantized coefficients for a block, such as may have been generated as an output of block 530 of FIG. 5. In some embodiments, the bitstream may indicate quantization parameters and/or a transform that was applied to the residual values of the block to generate the quantized coefficients.

At block 710, the decoder entropy decodes the entropy encoded quantized coefficients 702 to recreate the quantized coefficients 704. At block 720, the decoder may then apply an inverse quantization operation, based on information known about the quantization applied at the encoder, to recreate transform coefficients 706. Additionally, at block 730 the decoder may apply an inverse transform function to the transform coefficients 706 to generate prediction tree block residuals 708. The prediction tree block residuals may then be used to correct/adjust node values predicted for nodes of the block.

As can be seen, the entropy decoder 710, the inverse quantization 720, and the inverse transform 730 may reverse the entropy encoding performed at 530 of FIG. 5 along with the quantization performed at 520 and the transformation function applied at 510. This may result in recreating the prediction tree block residuals 502 at a decoder, or a lossy reconstructed version of the prediction tree block residuals 502.

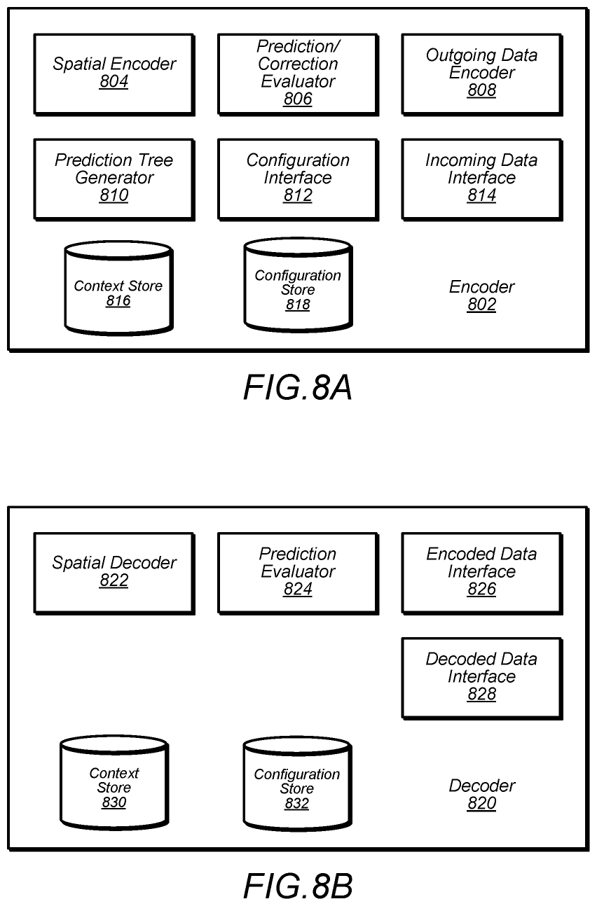

FIG. 8A illustrates components of an encoder, according to some embodiments. Encoder 802 may be a similar encoder as encoder 104 illustrated in FIG. 1A. Encoder 802 includes spatial encoder 804, octree tree generator 810, prediction/correction evaluator 806, incoming data interface 814, and outgoing data interface 808. Encoder 802 also includes context store 816 and configuration store 818.

In some embodiments, a spatial encoder, such as spatial encoder 804, may compress spatial information associated with points of a point cloud, such that the spatial information can be stored or transmitted in a compressed format. In some embodiments, a spatial encoder, such as spatial encoder 804, may utilize octrees to compress spatial information for points of a point cloud as discussed in more detail herein.

In some embodiments, compressed spatial information may be stored or transmitted with compressed attribute information or may be stored or transmitted separately. In either case, a decoder receiving compressed attribute information for points of a point cloud may also receive compressed spatial information for the points of the point cloud, or may otherwise obtain the spatial information for the points of the point cloud.

A prediction tree generator, such as prediction tree generator 810, may implement various techniques discussed above to generate a prediction tree to be encoded.

A prediction/correction evaluator, such as prediction/correction evaluator 806 of encoder 802, may determine predicted attribute values for points of a point cloud based on an inverse distance interpolation method using attribute values of the K-nearest neighboring points of a point for whom an attribute value is being predicted. The prediction/correction evaluator may also compare a predicted attribute value of a point being evaluated to an original attribute value of the point in a non-compressed point cloud to determine an attribute correction value. In some embodiments, a prediction/correction evaluator, such as prediction/correction evaluator 806 of encoder, 802 may adaptively adjust a prediction strategy used to predict attribute values of points in a given neighborhood of points based on a measurement of the variability of the attribute values of the points in the neighborhood.

An outgoing data encoder, such as outgoing data encoder 808 of encoder 802, may encode attribute correction values and assigned attribute values included in a compressed attribute information file for a point cloud. In some embodiments, an outgoing data encoder, such as outgoing data encoder 808, may select an encoding context for encoding a value, such as an assigned attribute value or an attribute correction value, based on a number of symbols included in the value. In some embodiments, values with more symbols may be encoded using an encoding context comprising Golomb exponential encoding, whereas values with fewer symbols may be encoded using arithmetic encoding. In some embodiments, encoding contexts may include more than one encoding technique. For example, a portion of a value may be encoded using arithmetic encoding while another portion of the value may be encoded using Golomb exponential encoding. In some embodiments, an encoder, such as encoder 802, may include a context store, such as context store 816, that stores encoding contexts used by an outgoing data encoder, such as outgoing data encoder 808, to encode attribute correction values and assigned attribute values.

In some embodiments, an encoder, such as encoder 802, may also include an incoming data interface, such as incoming data interface 814. In some embodiments, an encoder may receive incoming data from one or more sensors that capture points of a point cloud or that capture attribute information to be associated with points of a point cloud. For example, in some embodiments, an encoder may receive data from an LIDAR system, 3-D-camera, 3-D scanner, etc. and may also receive data from other sensors, such as a gyroscope, accelerometer, etc. Additionally, an encoder may receive other data such as a current time from a system clock, etc. In some embodiments, such different types of data may be received by an encoder via an incoming data interface, such as incoming data interface 814 of encoder 802.

In some embodiments, an encoder, such as encoder 802, may further include a configuration interface, such as configuration interface 812, wherein one or more parameters used by the encoder to compress a point cloud may be adjusted via the configuration interface. In some embodiments, a configuration interface, such as configuration interface 812, may be a programmatic interface, such as an API. Configurations used by an encoder, such as encoder 802, may be stored in a configuration store, such as configuration store 818.

In some embodiments, an encoder, such as encoder 802, may include more or fewer components than shown in FIG. 8A.

FIG. 8B illustrates components of a decoder, according to some embodiments.

Decoder 820 may be a similar decoder as decoder 116 illustrated in FIG. 1A. Decoder 820 includes encoded data interface 826, spatial decoder 822, prediction evaluator 824, context store 830, configuration store 832, and decoded data interface 828.

A decoder, such as decoder 820, may receive an encoded compressed point cloud and/or an encoded compressed attribute information file for points of a point cloud. For example, a decoder, such as decoder 820, may receive a compressed attribute information file and/or a compressed spatial information file. The compressed attribute information file and/or compressed spatial information file may be received by a decoder via an encoded data interface, such as encoded data interface 826. The encoded compressed point cloud may be used by the decoder to determine spatial information for points of the point cloud. For example, spatial information of points of a point cloud included in a compressed point cloud may be generated by a spatial decoder, such as spatial decoder 822. In some embodiments, a compressed point cloud may be received via an encoded data interface, such as encoded data interface 826, from a storage device or other intermediary source, wherein the compressed point cloud was previously encoded by an encoder, such as encoder 104. In some embodiments, an encoded data interface, such as encoded data interface 826, may decode spatial information. For example the spatial information may have been encoded using various encoding techniques as described herein, such as the various techniques for encoding geometry or other spatial information and/or attribute information as a prediction tree.

A prediction evaluator of a decoder, such as prediction evaluator 824, may select a starting point of a minimum spanning tree based on an assigned starting point included in a compressed attribute information file. In some embodiments, the compressed attribute information file may include one or more assigned values for one or more corresponding attributes of the starting point. In some embodiments, a prediction evaluator, such as prediction evaluator 824, may assign values to one or more attributes of a starting point in a decompressed model of a point cloud being decompressed based on assigned values for the starting point included in a compressed attribute information file. A prediction evaluator, such as prediction evaluator 824, may further utilize the assigned values of the attributes of the starting point to determine attribute values of neighboring points. For example, a prediction evaluator may select a next nearest neighboring point to the starting point as a next point to evaluate, wherein the next nearest neighboring point is selected based on a shortest distance to a neighboring point from the starting point in the minimum spanning tree. Note that because the minimum spanning tree is generated based on the same or similar spatial information at the decoder as was used to generate a minimum spanning tree at an encoder, the decoder may determine the same evaluation order for evaluating the points of the point cloud being decompressed as was determined at the encoder by identifying next nearest neighbors in the minimum spanning tree.

A decoder, such as decoder 820, may provide a decompressed point cloud generated based on a received compressed point cloud and/or a received compressed attribute information file to a receiving device or application via a decoded data interface, such as decoded data interface 828. The decompressed point cloud may include the points of the point cloud and attribute values for attributes of the points of the point cloud. In some embodiments, a decoder may decode some attribute values for attributes of a point cloud without decoding other attribute values for other attributes of a point cloud. For example, a point cloud may include color attributes for points of the point cloud and may also include other attributes for the points of the point cloud, such as velocity, for example. In such a situation, a decoder may decode one or more attributes of the points of the point cloud, such as the velocity attribute, without decoding other attributes of the points of the point cloud, such as the color attributes.

In some embodiments, the decompressed point cloud and/or decompressed attribute information file may be used to generate a visual display, such as for a head mounted display. Also, in some embodiments, the decompressed point cloud and/or decompressed attribute information file may be provided to a decision making engine that uses the decompressed point cloud and/or decompressed attribute information file to make one or more control decisions. In some embodiments, the decompressed point cloud and/or decompressed attribute information file may be used in various other applications or for various other purposes.

### Example Applications for Point Cloud Compression and Decompression

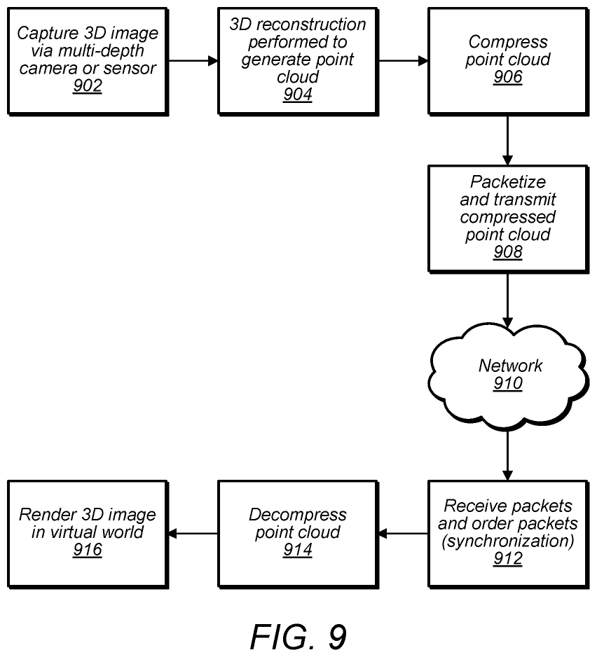

FIG. 9 illustrates compressed point clouds being used in a 3-D application, according to some embodiments.

In some embodiments, a sensor, such as sensor 102, an encoder, such as encoder 104, and a decoder, such as decoder 116, may be used to communicate point clouds in a 3-D application. For example, a sensor, such as sensor 102, at 902 may capture a 3D image and at 904, the sensor or a processor associated with the sensor may perform a 3D reconstruction based on sensed data to generate a point cloud.

At 906, an encoder such as encoder 104 may compress the point cloud and at 908 the encoder or a post processor may packetize and transmit the compressed point cloud, via a network 910. At 912, the packets may be received at a destination location that includes a decoder, such as decoder 116. The decoder may decompress the point cloud at 914 and the decompressed point cloud may be rendered at 916. In some embodiments a 3-D application may transmit point cloud data in real time such that a display at 916 represents images being observed at 902. For example, a camera in a canyon may allow a remote user to experience walking through a virtual canyon at 916.

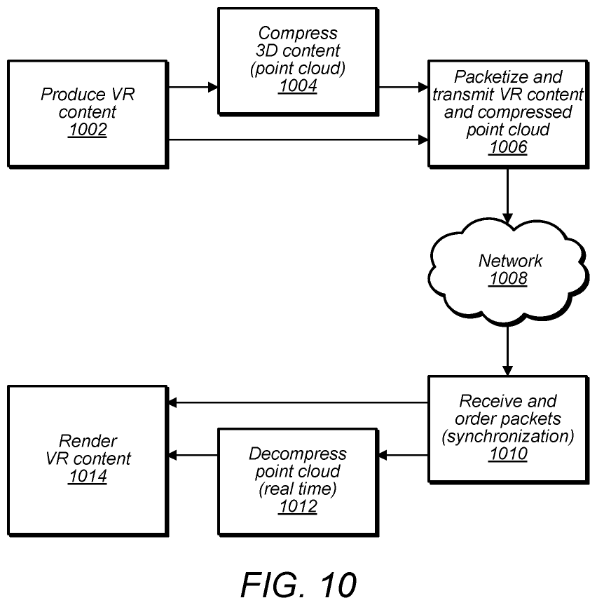

FIG. 10 illustrates compressed point clouds being used in a virtual reality (VR) or augmented reality (AR) application, according to some embodiments.

In some embodiments, point clouds may be generated in software (for example as opposed to being captured by a sensor). For example, at 1002 virtual reality or augmented reality content is produced. The virtual reality or augmented reality content may include point cloud data and non-point cloud data. For example, a non-point cloud character may traverse a landscape represented by point clouds, as one example. At 1004, the point cloud data may be compressed and at 1006 the compressed point cloud data and non-point cloud data may be packetized and transmitted via a network 908. For example, the virtual reality or augmented reality content produced at 1002 may be produced at a remote server and communicated to a VR or AR content consumer via network 1008. At 1010, the packets may be received and synchronized at the VR or AR consumer's device. A decoder operating at the VR or AR consumer's device may decompress the compressed point cloud at 1012 and the point cloud and non-point cloud data may be rendered in real time, for example in a head mounted display of the VR or AR consumer's device. In some embodiments, point cloud data may be generated, compressed, decompressed, and rendered responsive to the VR or AR consumer manipulating the head mounted display to look in different directions.

In some embodiments, point cloud compression as described herein may be used in various other applications, such as geographic information systems, sports replay broadcasting, museum displays, autonomous navigation, etc.

### Example Computer System

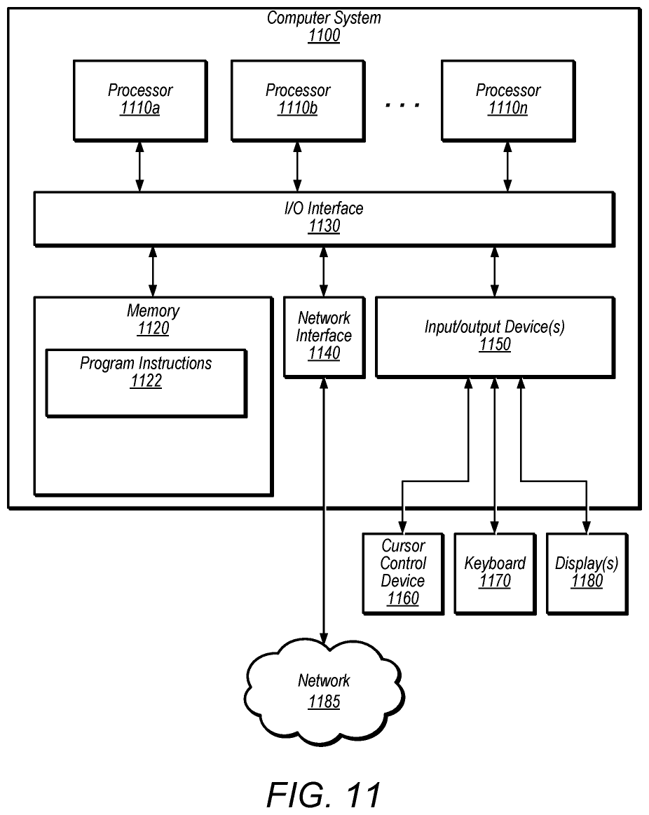

FIG. 11 illustrates an example computer system 1100 that may implement an encoder or decoder or any other ones of the components described herein, (e.g., any of the components described above with reference to FIGS. 1-10), in accordance with some embodiments. The computer system 1100 may be configured to execute any or all of the embodiments described above. In different embodiments, computer system 1100 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, a consumer device, video game console, handheld video game device, application server, storage device, a television, a video recording device, a peripheral device such as a switch, modem, router, or in general any type of computing or electronic device.

Various embodiments of a point cloud encoder or decoder, as described herein may be executed in one or more computer systems 1100, which may interact with various other devices. Note that any component, action, or functionality described above with respect to FIGS. 1-10 may be implemented on one or more computers configured as computer system 1100 of FIG. 11, according to various embodiments. In the illustrated embodiment, computer system 1100 includes one or more processors 1110 coupled to a system memory 1120 via an input/output (I/O) interface 1130. Computer system 1100 further includes a network interface 1140 coupled to I/O interface 1130, and one or more input/output devices 1150, such as cursor control device 1160, keyboard 1170, and display(s) 1180. In some cases, it is contemplated that embodiments may be implemented using a single instance of computer system 1100, while in other embodiments multiple such systems, or multiple nodes making up computer system 1100, may be configured to host different portions or instances of embodiments. For example, in one embodiment some elements may be implemented via one or more nodes of computer system 1100 that are distinct from those nodes implementing other elements.

In various embodiments, computer system 1100 may be a uniprocessor system including one processor 1110, or a multiprocessor system including several processors 1110 (e.g., two, four, eight, or another suitable number). Processors 1110 may be any suitable processor capable of executing instructions. For example, in various embodiments processors 1110 may be general-purpose or embedded processors implementing any of a variety of instruction set architectures (ISAs), such as the x86, PowerPC, SPARC, or MIPS ISAs, or any other suitable ISA. In multiprocessor systems, each of processors 1110 may commonly, but not necessarily, implement the same ISA.

System memory 1120 may be configured to store point cloud compression or point cloud decompression program instructions 1122 and/or sensor data accessible by processor 1110. In various embodiments, system memory 1120 may be implemented using any suitable memory technology, such as static random access memory (SRAM), synchronous dynamic RAM (SDRAM), nonvolatile/Flash-type memory, or any other type of memory. In the illustrated embodiment, program instructions 1122 may be configured to implement an image sensor control application incorporating any of the functionality described above. In some embodiments, program instructions and/or data may be received, sent or stored upon different types of computer-accessible media or on similar media separate from system memory 1120 or computer system 1100. While computer system 1100 is described as implementing the functionality of functional blocks of previous Figures, any of the functionality described herein may be implemented via such a computer system.

In one embodiment, I/O interface 1130 may be configured to coordinate I/O traffic between processor 1110, system memory 1120, and any peripheral devices in the device, including network interface 1140 or other peripheral interfaces, such as input/output devices 1150. In some embodiments, I/O interface 1130 may perform any necessary protocol, timing or other data transformations to convert data signals from one component (e.g., system memory 1120) into a format suitable for use by another component (e.g., processor 1110). In some embodiments, I/O interface 1130 may include support for devices attached through various types of peripheral buses, such as a variant of the Peripheral Component Interconnect (PCI) bus standard or the Universal Serial Bus (USB) standard, for example. In some embodiments, the function of I/O interface 1130 may be split into two or more separate components, such as a north bridge and a south bridge, for example. Also, in some embodiments some or all of the functionality of I/O interface 1130, such as an interface to system memory 1120, may be incorporated directly into processor 1110.

Network interface 1140 may be configured to allow data to be exchanged between computer system 1100 and other devices attached to a network 1185 (e.g., carrier or agent devices) or between nodes of computer system 1100. Network 1185 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1140 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1150 may, in some embodiments, include one or more display terminals, keyboards, keypads, touchpads, scanning devices, voice or optical recognition devices, or any other devices suitable for entering or accessing data by one or more computer systems 1100. Multiple input/output devices 1150 may be present in computer system 1100 or may be distributed on various nodes of computer system 1100. In some embodiments, similar input/output devices may be separate from computer system 1100 and may interact with one or more nodes of computer system 1100 through a wired or wireless connection, such as over network interface 1140.

As shown in FIG. 11, memory 1120 may include program instructions 1122, which may be processor-executable to implement any element or action described above. In one embodiment, the program instructions may implement the methods described above. In other embodiments, different elements and data may be included. Note that data may include any data or information described above.

Those skilled in the art will appreciate that computer system 1100 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1100 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1100 may be transmitted to computer system 1100 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1.-20. (canceled)

21. One or more non-transitory, computer-readable storage media, storing program instructions that when executed on or across one or more computing devices cause the one or more computing devices to:
generate a prediction tree comprising a plurality of nodes that correspond to a plurality of points, wherein to generate the prediction tree, the program instructions cause the one or more computing devices to determine respective nodes values for at least a portion of the plurality of nodes using one or more prediction techniques applied to one or more ancestor nodes of respective nodes of the portion;
identify different segments of the prediction tree;
divide the segments into respective blocks, wherein node values of nodes included in the respective blocks are predicted based on node values of nodes included in one or more predecessor blocks in the segment;
encode the blocks of the prediction tree; and
send or store the encoded blocks.

22. The one or more non-transitory, computer-readable storage media of claim 21, wherein the one or more prediction techniques comprise:
a delta prediction technique, wherein a node value for a child node is predicted as a difference from a node value of a parent node;
a linear prediction technique, wherein a node value for a child node is predicted based on a relationship between a parent node and a grandparent node of the child node; or
a parallelogram prediction technique, wherein a node value for a child node is determined based on a relationship between a parent node, a grandparent node, and a great grandparent node of the child node.

23. The one or more non-transitory, computer-readable storage media of claim 21, wherein, to generate the prediction tree, the program instructions cause the one or more computing devices to:
determine respective nodes values for another portion of the plurality of nodes, wherein the respective node values for the other portion of the plurality of nodes are not predicted.

24. The one or more non-transitory, computer-readable storage media of claim 21, wherein the one or more ancestor nodes comprise one or more parent, grandparent, or great-grandparent nodes.

25. The one or more non-transitory, computer-readable storage media of claim 21, wherein, to encode the blocks of the prediction tree, the program instructions cause the one or more computing devices to:
apply a transform to residual values of the blocks of the prediction tree; and
apply quantization to coefficients generated from the transformed residual values of the blocks of the prediction tree.

26. The one or more non-transitory, computer-readable storage media of claim 21, wherein, to identify the different segments of the prediction tree according to a graph traversal technique, the program instructions cause the one or more computing devices to:
traverse nodes of the prediction tree from a root node of the prediction tree to a first leaf node of the prediction tree to identify a first segment of the segments; and
iteratively traverse other nodes of the prediction tree from next nodes identified according to the graph traversal technique to other leaf nodes until remaining nodes in the prediction tree are included in another one of the segments.

27. The one or more non-transitory, computer-readable storage media of claim 21, wherein the program instructions cause the one or more computing devices to:
apply a transform to residual attribute values for nodes of a block, wherein the transform transforms the residual attribute values of the nodes of the block into transfer function coefficients, and wherein the transform determines the transform function coefficients based on:
relationships between the block and other blocks of the prediction tree; and
geometry relationships between the nodes of the block in a geometry of a point cloud, wherein the point cloud comprises the plurality of points.

28. The one or more non-transitory, computer-readable storage media of claim 21, wherein a respective prediction technique for predicting node values of one of the blocks is different than a respective prediction technique for predicting node values of another one of the blocks.

29. A method, comprising:
generating a prediction tree comprising a plurality of nodes, wherein:
respective ones of the plurality of nodes correspond to respective points that make up a point cloud, wherein generating the prediction tree comprises determining respective nodes values for at least a portion of the plurality of nodes using one or more prediction techniques applied to one or more ancestor nodes of respective nodes of the portion;
identifying different segments of the prediction tree;
dividing the segments into respective blocks, wherein node values of nodes included in the respective blocks are predicted based on node values of nodes included in one or more predecessor blocks in the segment;
encoding the blocks of the prediction tree; and
sending or store the encoded blocks.

30. The method of claim 29, wherein different prediction techniques of the one or more prediction techniques are signaled for different nodes included in a same block.

31. The method of claim 30, further comprising:
applying a transform selected for a block to residual values calculated based on predictions that use different prediction techniques for two or more nodes of the block; and
signaling the transform selected for the block at a block-level.

32. The method of claim 31, wherein:
a first transform is signaled at the block-level for decompressing attribute values of the plurality of nodes; and
a different transform is signaled at the block-level for decompressing geometry values of the plurality of nodes.

33. The method of claim 31, wherein a quantization parameter to be applied to coefficients resulting from the transform being applied to the residual values is signaled at a block-level.

34. The method of claim 29, further comprising:
performing a rate distortion optimization (RDO) analysis to determine a number of nodes to be included in the blocks.

35. The method of claim 29, further comprising:
applying a transform to residual attribute values for nodes of a block, wherein the transform is selected from a set of supported transforms, comprising:
a one-dimensional discrete cosine transform;
a wavelet transform;
a discrete wavelet transform;
a Haar transform;
a Hadamard transform;
a graph transform; or
a lifting scheme.

36. One or more non-transitory, computer-readable storage media, storing program instructions that, when executed on or across one or more computing devices, cause the one or more computing devices to:
receive a plurality of encoded blocks of a prediction tree for a plurality of points, wherein the encoded blocks comprise encoded node values;
decode the blocks of the prediction tree, wherein, in decoding the prediction tree, the program instructions cause the one or more computing devices to further:
decode individual ones of the blocks according to respectively determined prediction techniques for the blocks to decode points associated with the blocks; and
store or render the plurality of points decoded from the blocks of the prediction tree.

37. The one or more non-transitory, computer-readable storage media of claim 36, wherein to decode an individual one of the blocks, the program instructions cause the one or more computing devices to:
apply an inverse transform to coefficient values signaled for the block to determine residual values for nodes of the block,
wherein the inverse transform to be applied is indicated at a block-level.

38. The one or more non-transitory, computer-readable storage media of claim 37, wherein to decode an individual one of the blocks, the program instructions further cause the one or more computing devices to:
apply an inverse quantization to coefficient values signaled for the block prior to applying the inverse transform,
wherein the inverse quantization to be applied is indicated at the block-level.

39. The one or more non-transitory, computer-readable storage media of claim 37, wherein to decode an individual one of the blocks, the program instructions further cause the one or more computing devices to:
predict node values for the nodes of a block based on prediction techniques indicated in the encoded blocks; and
apply the residual values to the predicted node values to determine reconstructed node values for the nodes of the block.

40. The one or more non-transitory, computer-readable storage media of claim 36, wherein the prediction techniques are signaled at a block-level in the encoded blocks.
